(19) United States
(12) Patent Application Publication
(10) Pub. No.: US 2025/0108747 A1
(43) Pub. Date: Apr. 3, 2025

(54) SYSTEM FOR HOLDING AN ARTICLE IN A VEHICLE

(71) Applicant: Faurecia India Private Limited, Pune (IN)

(72) Inventors: Sandeep PATIL, Pune (IN); Annasaheb BHUJADE, Pune (IN)

(21) Appl. No.: 18/901,560

(22) Filed: Sep. 30, 2024

(30) Foreign Application Priority Data
Sep. 29, 2023 (IN) 202321065736

(51) Int. Cl. B60N 3/10

(52) U.S. Cl. CPC B60N 3/102

(57) ABSTRACT

A system for holding an article in a vehicle. The system includes a housing with a plurality of sidewalls defining a storage space for accommodating a holding mechanism and one or more lids adapted to slide over the storage space to open the storage space. The holding mechanism is adapted to move in between a retracted and deployed position. In the retracted position, the holding mechanism is arranged within the housing, and in the deployed position, the holding mechanism is at least partially moved out of the storage space and is adapted to accommodate the article therein and upon sliding of the one or more lids towards the open position, which causes opening of the storage space together with activation of the holding mechanism towards the deployed position.

### TECHNICAL FIELD

The present disclosure relates generally to the field of article holding system/equipment in a vehicle. More particularly, the present disclosure relates to a system for holding an article, wherein the system can be integrated in an interior part or body of a vehicle such as a trunk body or door panel of the vehicle.

### BACKGROUND

The following description includes information that may be useful in understanding the present invention. It is not an admission that any of the information provided herein is prior art or relevant to the presently claimed invention, or that any publication specifically or implicitly referenced is prior art.

Generally, new generation vehicles are integrated with cup or bottle holding units in an interior body of a vehicle. These provide ease in positioning and holding articles like cups, bottles, glasses, cans, or other such containers. Such cup or bottle holding units are generally designed thoughtfully in an ergonomic way so that a passenger may get to keep and access the container or the article in an easier way without much effort. Thus, all these holding units are arranged near the passenger seating area like the armrest, inner door panel, dashboard, and the like.

These holding units are arranged to ease the driving experience of the passengers. However, as they are an extension of the interior body on the inner side of the vehicle, these holding units cause a reduction in the inner space triggering discomfort to the passengers.

As known in conventional art, the movable cup holding units remain closed when not in use and open to allow the passenger to position the cup or a container, like a bottle, within a cavity provided in these cup holders.

Some of the cup holding units comprise a movable section that is typically arranged in line with the interior body of the vehicle, and while using the cup holder, the movable section moves within the interior body of the vehicle such that a cavity gets created in the body which allows an accommodation of the container. However, such movable cup holding units expose the inner components of the cup holding units as well as the vehicle to the ambient environment causing dust to enter through the cavity. This decreases the durability of the cup holding units. As a result of this, there is a rapid degradation and then failure of the cup holding unit and its components.

Further, any kind of spillage in the cavity makes the cleaning of these cup holding units difficult and damages the components of the vehicle. Moreover, these cup holding units are structurally complex in construction and occupy a major area of the interior space as well as the interior body of the vehicle.

There is, therefore, a need for a new, simple and compact system for holding an article with a housing such that the housing can be integrated as an interior accessory for a vehicle or as an interior body of the vehicle.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY

Some of the objects of the present disclosure, which at least one embodiment herein satisfies are as listed herein below.

It is an object of the present disclosure to provide a system for holding an article.

It is another object of the present disclosure to provide a system for holding an article such that the system may be integrated as an interior accessory of a vehicle.

It is an object of the present disclosure to provide a holding mechanism to receive and accommodate an article in its deployed position and the holding mechanism is at least partially covered by one or more lids in it retracted position.

These and other objects of the present invention will become readily apparent from the following detailed description taken in conjunction with the accompanying drawings.

The present disclosure relates generally to the field of article holding equipment. More particularly, the present disclosure relates to a system for holding an article, wherein the system can be integrated as an interior accessory of a vehicle.

According to an aspect, the present disclosure pertains to a system for holding an article in a vehicle. The system may comprise a housing, and a holding mechanism. The housing may comprise a plurality of sidewalls for defining a storage space. The storage space may further accommodate the holding mechanism. The one or more lids may be adapted to slide over the storage space of the housing in between an open position and a closed position to open and close the storage space of the housing, respectively. The holding mechanism may further be adapted to move in between a retracted position and a deployed position, wherein, in the retracted position, the holding mechanism may be arranged within the housing, and in the deployed position, the holding mechanism may be configured to at least partially move out of the storage space of the housing and may further be adapted to receive and accommodate the article. Further, upon sliding of the one or more lids towards the open position, opening of the storage space may be caused together with an activation of the holding mechanism towards the deployed position.

In an aspect, the one or more lids may be slidable in a first direction and the holding mechanism may be configured to move in a second direction substantially perpendicular to the first direction.

In another aspect, the holding mechanism may further comprise one or more holding elements and a bottom plate for accommodating and holding the article.

In an aspect of the present disclosure, the system may also comprise a sliding mechanism coupled with at least one sidewall among the plurality of sidewalls and operatively configured with the one or more lids; such that, upon sliding of the one or more lids (114) towards the open position, the sliding mechanism (130) activates the holding mechanism (120) towards the deployed position.

In an aspect, the sliding mechanism may further comprise one or more rails and one or more sliding elements configured with a rope and a pulley assembly, wherein the sliding mechanism may be operatively coupled with the one or more lids via the rope and the pulley assembly and the one or more holding elements. The sliding mechanism may enable the sliding of the holding mechanism, and wherein the sliding mechanism may further be configured to support the holding mechanism inside the housing in a retracted position and outside the housing in the deployed position.

In one aspect, each sliding elements may further comprise a slot at an end away from the pulley for facilitating a delay in sliding the sliding elements in the deployed position. More particularly, the rope with a first end slidably arranged within the slot of the sliding elements and a second end coupled to the one or more lid: such that upon sliding the one or more lids towards the open position;
firstly, only the rope slides within the slot until the lid moves to an intermediate open position, and
then, the sliding element along with the rope slides towards the deployed position of the holding mechanism.

In another aspect of the present disclosure, the system may comprise a rotation mechanism. The rotation mechanism may further comprise a rack and a pinion arrangement operatively coupled with the rope and pulley assembly. The pinion may comprise a roller coaxial with the pinion such that the axis of rotation of the roller coincides with the axis of rotation of the pinion, and wherein the axis of rotation of the roller and the pinion may become parallel with the axis of rotation of the pulley. The rope may be adapted to be fixed onto the roller such that a rotation of the roller with the pinion may causes winding and unwinding of the rope onto the roller, which may be resulted by sliding of the one or more lids facilitating the movement of the holding mechanism in between the retracted position and deployed position.

In an aspect, the winding and unwinding of the rope onto the roller is the result of an engagement of a first locking pin of the pinion with a second locking pin of the roller.

In an aspect, the holding mechanism may be configured to at least partially move out of the space of the housing, after the engagement of the locking first pin of the pinion with the second locking pin of the roller, wherein the one or more lids are configured to at least partially open before the holding mechanism at least partially moves out of the housing in the deployed position.

In another aspect, the activation of the holding mechanism to the deployed position may facilitate an expansion or contraction of the one or more holding elements and the bottom plate, corresponding to a shape or a size of the article, wherein the size of the article corresponds to a width of a base of the article.

In another aspect, the sliding of the one or more lids may be in a linear direction with respect to the at least one sidewall, and wherein the activation of the holding mechanism may further cause an arcuate movement of the one or more holding elements and the bottom plate, upon the sliding of the one or more lids.

In an aspect, the sliding of the one or more lids may cause an arcuate movement of the one or more sliding elements, such that the arcuate movement of the one or more sliding elements may further cause an arcuate movement of the one or more holding elements and the bottom plate at least partially outside the housing to activate the holding mechanism towards the deployed position.

In another aspect, each of the one or more holding elements may also comprise a plurality of intersecting diagonal bars hingedly connected to form scissor-like structure, wherein a bottom end of at least one of the diagonal bars may be attached to the bottom plate.

In an aspect, the housing may be adaptively configured in an interior body or a part of an interior body of a vehicle such as truck or a trim part of a door panel, wherein the holding mechanism may further be configured to be hidden under the housing.

In another aspect, the one or more lids is a pair of lids sliding opposite to each other. The pair of lids is connected to respective pair of sliding members 132-1 with respective pair of holding elements 122. The pair of lids may further be adaptively configured as an interior trim panel of a vehicle. The article may be selected from a group comprising cup, a bottle, a container, or an electronic equipment. The system may be configured to operate manually and/or automatically. The actuator is any electric motor selected from a group comprising a servo motor, a rotary motor, or the like.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates an exemplary isometric view of a system for holding an article, in a closed or retracted position, in accordance with an embodiment of the present disclosure.

FIG. 1B illustrates an exemplary isometric view of a holding mechanism of the system for holding the article, in accordance with an embodiment of the present disclosure.

FIG. 1C illustrates an exemplary partial front view of the system for holding the article, in a completely open or deployed position, in accordance with an embodiment of the present disclosure.

FIG. 2A illustrates an exemplary top view of the system for holding the article, in a closed or stowed position, in accordance with a first embodiment of the present disclosure.

FIG. 2B-1 illustrates an exemplary top view of the system for holding the article, wherein the lids is/are in a partially closed or partially open position or intermediate position, in accordance with the first embodiment of the present disclosure.

FIG. 2B-2 illustrates an exemplary top view of the system for holding the article, wherein the lids is/are and the holding mechanism is in a completely open and deployed position, in accordance with the first embodiment of the present disclosure.

FIG. 2C illustrates an exemplary top view of the system for holding the article with a plunger system for moving the holding mechanism along with the sliding mechanism away from the housing, in accordance with the first embodiment of the present disclosure.

FIG. 3A illustrates an exemplary isometric view of a sliding mechanism with a one or more rail, one or more sliding elements and a rope and a pulley assembly, in a position wherein upon actuation of the one or more lids only the rope of the sliding mechanism is moved within the slot, in accordance with the first embodiment of the present disclosure.

FIG. 3B illustrates an exemplary isometric view of the sliding mechanism with a one or more rail, one or more sliding elements and the rope and the pulley assembly, in a position wherein after initial movement of the rope within the slot, the rope along with the one or more sliding elements is moving to enable the holding mechanism to move from the retracted position to the deployed position, in accordance with the first embodiment of the present disclosure.

FIG. 3C illustrates an exemplary isometric view of the sliding mechanism with a one or more rail, one or more sliding elements and the rope and the pulley assembly, in a position wherein after actuation of the one or more lids the rope along with the one or more sliding elements is moved from the retracted position to the deployed position, in accordance with the first embodiment of the present disclosure.

FIG. 4 illustrates an exemplary isometric view of a system for holding an article comprising a rotating mechanism with a rack and a pinion arrangement, in accordance with a second embodiment of the present disclosure.

FIG. 5A illustrates an exemplary top view of the system for holding an article comprising the rack and pinion arrangement in connection with the rope and pulley assembly, in a closed or retracted position, in accordance with a second embodiment of the present disclosure.

FIG. 5B illustrates an exemplary top view of the system for holding an article comprising the rack and pinion arrangement in connection with the rope and pulley assembly, in the partially closed or open position and wherein the first and second pin abut/engages, respectively, in accordance with the second embodiment of the present disclosure.

FIG. 5C illustrates an exemplary top view of the system for holding an article comprising the rack and pinion arrangement in connection with the rope and pulley assembly, in a completely open or deployed position, in accordance with the second embodiment of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

The present disclosure relates generally to the field of article holding equipment. More particularly, the present disclosure relates to a system for holding an article, wherein the system can be integrated as an interior accessory of a vehicle.

According to an aspect, the present disclosure pertains to a system for holding an article. The system may comprise a housing, and a holding mechanism. The housing may comprise a plurality of sidewalls for defining a storage space. The storage space may further accommodate the holding mechanism. The one or more lids may be adapted to slide over the storage space of the housing in between an open position and a close position to open and close the storage space of the housing, respectively. The holding mechanism may further be adapted to move in between a retracted position and a deployed position, wherein, in the retracted position, the holding mechanism may be arranged within the housing, and in the deployed position, the holding mechanism may be configured to at least partially move out of the storage space and may further be adapted to receive and accommodate the article. Further, upon sliding of the one or more lids towards the open position, opening of the storage space may be caused together with an activation of the holding mechanism towards the deployed position.

In an aspect of the present disclosure, the system may also comprise a sliding mechanism coupled with at least one sidewall among the plurality of sidewalls and operatively configured with the one or more lids. The sliding mechanism may allow sliding of the one or more lids between a closed position and an open position with respect to the plurality of sidewalls to open and close the storage space, respectively.

In another aspect of the present disclosure, the system may also comprise a rotation mechanism. The rotation mechanism may further comprise a rack and a pinion arrangement operatively coupled with the rope and pulley assembly. The pinion may comprise a roller coaxial with the pinion such that the axis of rotation of the roller coincides with the axis of rotation of the pinion, and wherein the axis of rotation of the roller and the pinion may become parallel with the axis of rotation of the pulley. The rope may be adapted to be fixed onto the roller such that a rotation of the roller with the pinion causes winding and unwinding of the rope onto the roller.

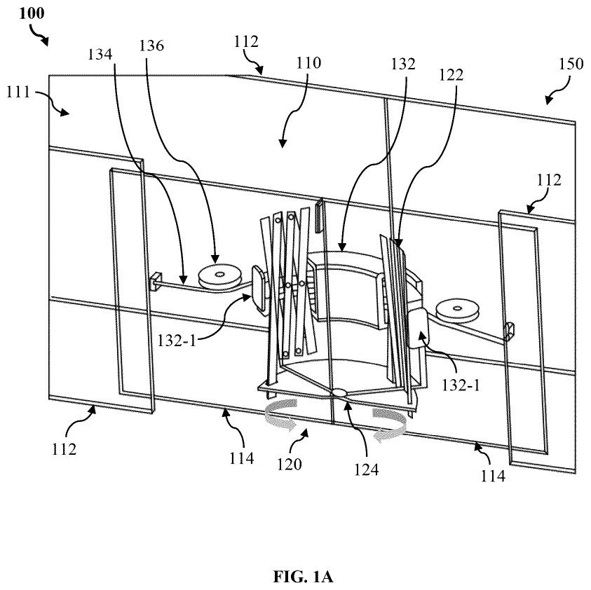

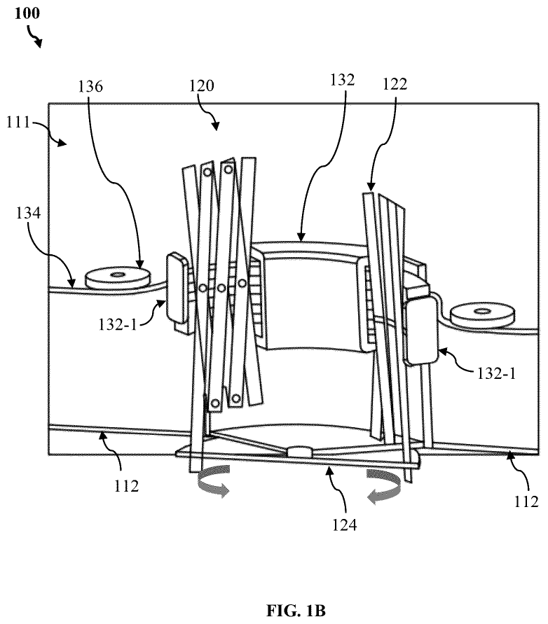

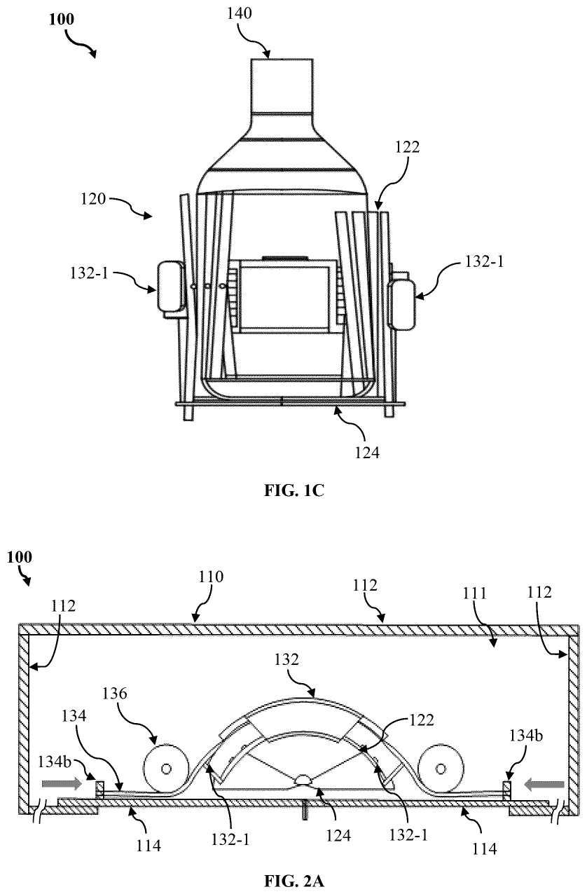

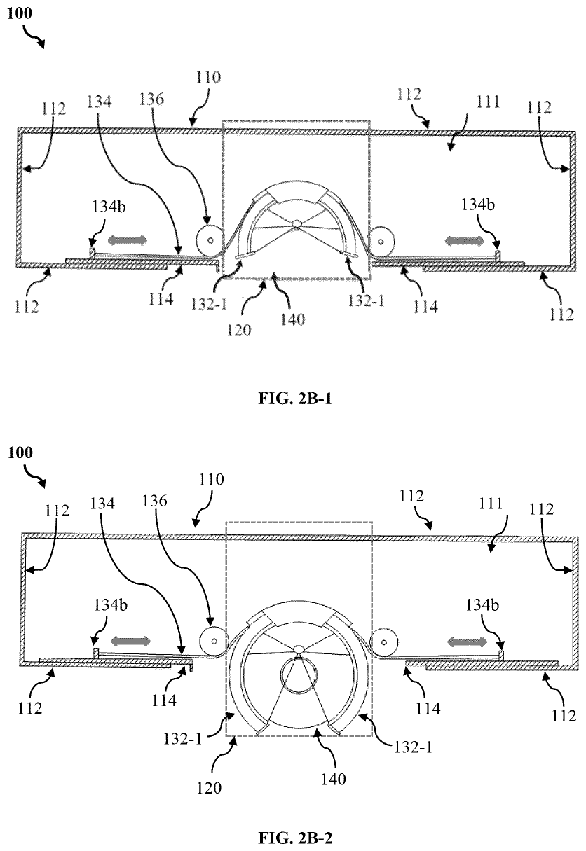

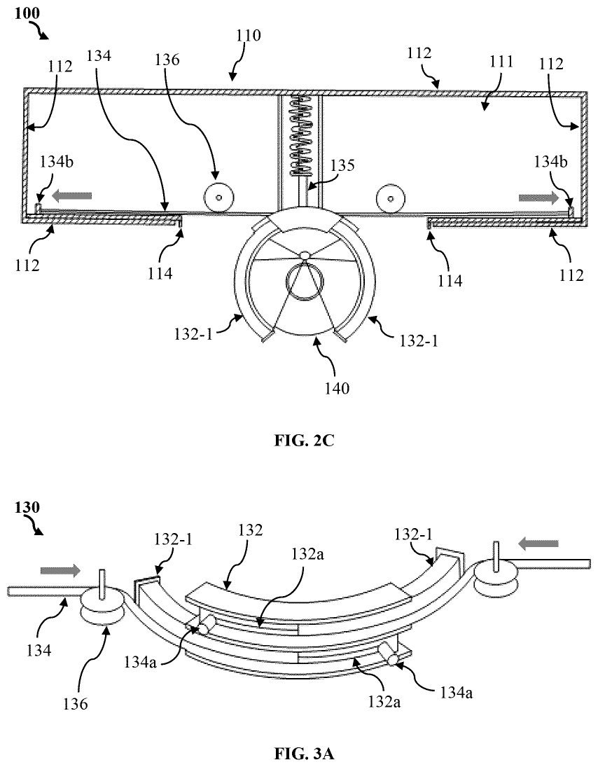

As illustrated in FIGS. 1A to 2C, a system 100 for holding an article 140 is disclosed. The system 100 can include a housing 110, a holding mechanism 120, and a sliding mechanism 130. The housing 110 can include a plurality of sidewalls 112 and one or more lids 114. The housing 110 can be adapted for accommodating the holding mechanism 120 and the sliding mechanism 130. The holding mechanism 120 can include one or more holding elements 122 and a bottom plate 124. The holding mechanism 120 can further be adapted to receive and accommodate the article 140.

In an embodiment, the sliding mechanism 130 can be coupled with at least one sidewall among the plurality of sidewalls 112 of the housing 110. The sliding mechanism 130 can also be operatively configured with the lids 114 of the housing 110.

In an embodiment, the sliding of the lids 114 of the housing 110 towards the open position can cause opening of the housing 110 together with an activation of the holding mechanism 120 towards a deployed position where at least a portion of the holding mechanism 120 comes out of the housing 110 to facilitate holding of the article 140 within the holding mechanism 120.

In an embodiment, the sliding mechanism 130 can include one or more rails 132 and one or more sliding elements 132-1 slidably configured in each of the rails 132. The sliding elements 132-1 can be configured with a rope 134 and a pulley 136 assembly. The sliding mechanism 130 can be operatively coupled with the one or more lids 114 via the rope 134 and the pulley 136 assembly.

In an embodiment, the sliding mechanism 130/sliding elements 132-1 can also support the holding mechanism 120 within the housing 110 in a retracted position and outside the housing 110 in the deployed position. The activation of the holding mechanism 120 to the deployed position can facilitate an expansion or contraction of the one or more holding elements 122 and the bottom plate 124. This expansion or contraction of the holding elements 122 and the bottom plate 124 can correspond to a shape or a size of the article 140. Further, the size of the bottom plate 124 can be based on a width of a base of the article 140 or a maximum width of the article 140.

In an embodiment, the lids 114 can slide forward and backward or to and fro in a linear direction with respect to the at least one sidewall among the plurality of the sidewalls 112. The activation of the holding mechanism 120 can cause an arcuated movement of the holding elements 122 and the bottom plate 124, upon the sliding of the lids 114.

In an embodiment, the sliding of the lids 114 of the housing 110 can cause an arcuated movement of the sliding elements 132-1, such that the arcuated movement of the sliding elements 132-1 can further cause an arcuated movement of the holding elements 122 and the bottom plate 124 at least partially or completely outside the housing 110 through the one or more lids 114 to activate the holding mechanism 120 into the deployed position.

In an embodiment, each of the holding elements 122 can include a plurality of intersecting diagonal bars or links that can be hingedly connected to form a scissor-like structure. Further, a bottom end of at least one of the holding elements 122 (diagonal bars or links) can be attached to the bottom plate 124 and the remaining of the one or more holding elements 122 can be attached with the sliding elements 132-1. Such an arrangement of the holding elements 122 in connection with the sliding mechanism 130 and the bottom plate 124 can cause an arcuated movement of the bottom plate 124 in addition to an arcuated movement of the holding elements (diagonal bars or links) 122, due to a sliding movement of the lids 110.

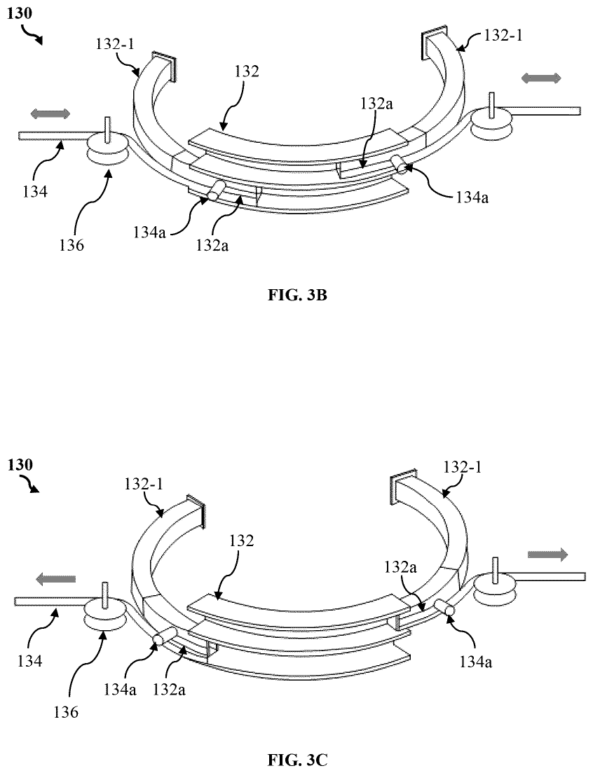

In an embodiment, as illustrated in FIGS. 3A to 3C, the sliding elements 132-1 can be attached to the rope 134 and the pulley 136 assembly such that a sliding movement of a lid of the one or more lids 114 can cause a sliding movement of the sliding elements 132-1 so that the activation of the holding mechanism 120 is initiated from the retracted position to a deployed position outside the housing 110, and vice-versa.

Accordingly to a first embodiment, referring to FIGS. 1A to 3C, the housing 110 can be adaptively configured to be in an interior body 150 or a part of an interior body 150 of a vehicle such that the one or more lids 114 can form at least a portion of an interior trim panel 150 (also referred to as an interior body 150, herein) of the vehicle. Further, the holding mechanism 120 can also configured to be a hidden mechanism under the housing 110. The one or more sliding elements further comprise a slot 132a at an end away from the pulley 136 such that a first end 134a of the rope 134 is slidingly arranged within the slot 132a and the other end 134b of the rope 134 is fixed to the one or more lid 114. In an embodiment as shown in FIG. 2C a plunger 135 is arranged for pushing the holding mechanism 120 away from the storage space 111 of the housing 110.

Accordingly to the first embodiment, referring FIGS. 1A to 3C; wherein, the one or more lids 114 is a pair of lids sliding opposite to each other. The pair of lids is connected to respective pair of sliding members 132-1 with respective pair of holding elements 122. In implementation, when a user/passenger manually pushes the one or more lids 114 from the closed position towards the open position;
firstly, only the first end 134a of the rope 134 slides within the slot 136 until the one or more lids moves to an intermediate open position or till the first end 134a of the rope 134 travels and abut a distal end of the slot 136, and
then, the one or more sliding elements 132-1 along with the rope 134 slides towards the deployed position of the holding mechanism 120, enabling the expansion of the holding elements and the bottom plate adapted to receive the article therein/thereon.

In an alternate embodiment, the pair of lids 114 can be driven by an electric motor (not shown).

In an embodiment, the system 100 can configured to be operated manually and/or automatically. The automatic operation of the system 100 can include use of a motorised mechanism or the like for sliding movement of the lids 114 between the closed position and open position to activate the holding mechanism between the deployed position and the retracted position. Further, the manual operation may involve application of a force or sliding of the lid 114 by users/passengers to move the lids 114 between the closed position and open position to activate the holding mechanism between the deployed position and the retracted position.

In an embodiment, the article 140 can be selected from a variety of containers or object that can be accommodated by the system 100 using the holding mechanism 120. The article 140 can include a cup, a bottle, a container, and electronic equipment, but is not limited to the like.

In an embodiment, the proposed system 100 can be configured in an interior body/trim 150 of a vehicle as an on-demand article holding unit, which can securely stay within the interior body/trim 150 of the vehicle when not in use, and can be accessed easily with a single sliding motion of the lids 114 by a passenger of the vehicle as and when required to accommodate the article 140. This allows a zero exposure of the interior body/trim 150 of the vehicle to the dust, liquid, and the ambient environment. In this way, the proposed system 100 can improve the aesthetics of the car interior and the article holding unit, and thus, inner components of the vehicle can be saved from unnecessary contamination and degradation from the dust and the ambient environment.

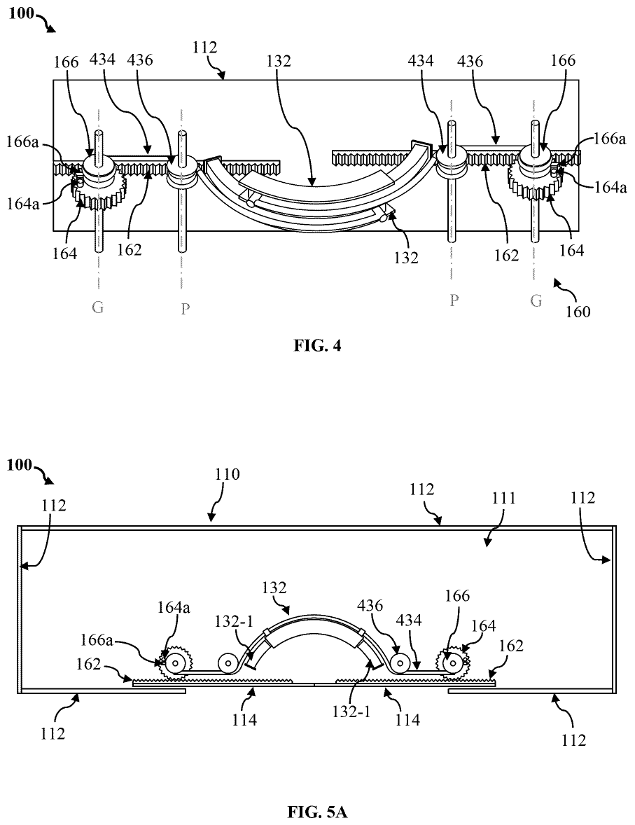

Accordingly to a second embodiment, referring FIGS. 1A-1C and 4-5C, the system 100 comprises a rotation mechanism 160 for opening and closing of the lids 114, thereby actuating the sliding mechanism 130 and then the holding mechanism 120. The rotation mechanism 160 may further comprise one or more rack 162 and pinion 164 arrangement operatively coupled with the rope 434 and pulley 436 assembly. The pinion 164 comprises a roller 166, wherein the roller 166 is operatively adapted to be coaxial with the pinion 164 such that the axis of rotation of the roller 166 coincides with the axis of rotation of the pinion 164 (i.e., the roller 166 and the pinion 164 has the same axis of rotation G. Further, the axis of rotation G of the roller 166 and the pinion 164 is parallel with the axis of rotation P of the pulley 436, as shown in FIG. 4. More particularly, the rack 162 is arranged on a B-surface (unexposed surface) of the one or more lids 114 engaged with the pinion 164. Further the pinion 164 has a first locking pin 164a adapted to abut with a second locking pin 166a of the roller. In an embodiment a rear surface of the one or more lids (114) itself defines the rack.

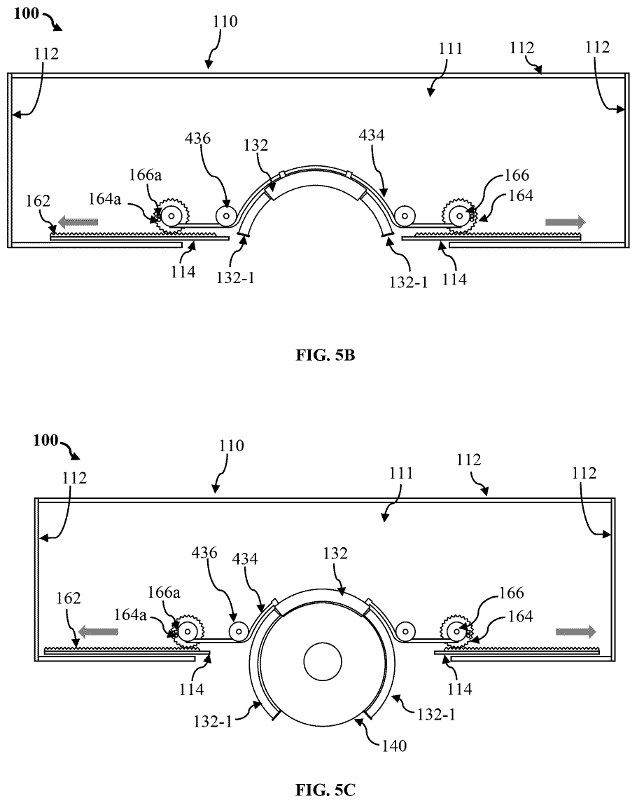

According to the second embodiment as shown in FIG. 4-5C, wherein, the one or more lids 114 is a pair of lids sliding opposite to each other. The pair of lids 113 is connected to respective pair of sliding members 132-1. In implementation, when the pinion 164 is driven in first direction may be by an electric motor (not shown):
only the rack along with the lids 114 move towards the open position until,
the first locking pin 164a abut or engage with the second locking pin 166a to wind/roll the rope 134 on the roller 166 and simultaneously slides the sliding element 132-1 on the rail 132 enabling the expansion of the holding element and the bottom plate towards the deployed position adapted for receiving the articles thereon/therein.

In an alternate embodiment, the pinion 164 can be driven manually by a rotatable knob (not shown).

In an embodiment, the axes of rotation G and P generally have same rotational direction so as to facilitate the opening and closing of the lids 114, thereby actuating of the holding mechanism 120 towards deployed position and the retracted position according to the rotational direction.

In an aspect, the holding mechanism 120 at least partially moves out from the housing only after the engagement of the first locking pin 164a of the pinion 164 with the second locking pin 166a of the roller 166, wherein the lids 114 then at least partially open.

In another aspect, the activation of the holding mechanism 120 to the deployed position facilitates an expansion or contraction of the holding elements 122 and the bottom plate 124, corresponding to a shape or a size of the article 140, wherein the size of the article 140 corresponds to a width of a base of the article 140.

Further, the sliding of the one or more lids 114 is in a linear direction with respect to the at least one sidewall enables the activation of the holding mechanism 120 causes an arcutate movement of the one or more holding elements 122 and the bottom plate 124. More particularly, the sliding of the one or more lids 114 causes an arcutate movement of the sliding elements 132-1 of the sliding mechanism 132, such that the arcutate movement of the sliding elements 132-1 causes arcutate movement of the holding elements 122 and the bottom plate 124 at least partially outside the housing 110 to activate the holding mechanism 120 into the deployed position.

It would be appreciated that although aspects of the present disclosure are explained with respect to a holding mechanism 120 comprising holding elements 122 as bars or links in scissor like fashion, those skilled in the art would appreciate that, any other arrangement for holding the article 140 such as, but not limited to, a clamp arrangement, fabric arrangement, or the like may also be utilized, without departing from the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

The present disclosure provides a system for holding an article, wherein the system can be integrated as an interior accessory for a vehicle.

The proposed disclosure provides a system for holding an article as an on-demand article holding unit for a vehicle.

The present disclosure provides a system for holding an article for aesthetics enrichment due to a holding mechanism being a hidden mechanism in the vehicle body.

The present disclosure provides a system for holding an article that consumes less space inside the vehicle and provides extra comfort to the passengers due to the spacious interiors of the vehicle.

The present disclosure provides a system for holding an article that can be implemented in a variety of interior body parts of a vehicle.

The present disclosure provides a holding mechanism as a hidden mechanism in an interior body of a vehicle.

The present disclosure provides a housing for the system for holding the article, as an interior body or a part of an interior body of a vehicle.

The present disclosure provides a sliding mechanism for the activation and/or deactivation of the holding mechanism.

The present disclosure provides a system for holding an article, which comes out of the interior body of the vehicle for accommodating articles when required, and remains within the interior body when not in use.

The present disclosure provides a rack and a pinion arrangement in connection with a rope and pulley assembly, within the sliding mechanism, enabling the activation and/or deactivation of the holding mechanism, manually or automatically.

The present disclosure provides a system for holding an article which prevents/avoids exposure to dust, liquid, and ambient environment on the inner components of the article holding unit as well as the inner components of the vehicle due to a separate housing of the system.

The present disclosure provides a system for holding an article which restricts access to the inner components of the article holding unit as well as the inner components of the vehicle due to a separate housing of the system.

1. A system for holding an article in a vehicle, the system comprising:
a housing comprising a plurality of sidewalls defining a storage space for accommodating a holding mechanism therein; and
one or more lids adapted to slide over the storage space of the housing in between an open position and a close position to open and close the storage space of the housing, respectively;
the holding mechanism is adapted to move in between a retracted position and a deployed position,
wherein, in the retracted position, the holding mechanism is arranged within the housing, and in the deployed position, the holding mechanism is at least partially moved out of the storage space of the housing and is adapted to receive and accommodate the article therein; and
wherein sliding of the one or more lids towards the open position causes opening of the storage space together with an activation of the holding mechanism towards the deployed position.

2. The system as claimed in claim 1, wherein the one or more lids is slidable in a first direction and the holding mechanism is movable in a second direction substantially perpendicular to the first direction.

3. The system as claimed in claim 1, wherein the holding mechanism comprises one or more holding elements and a bottom plate for accommodating and holding the article.

4. The system as claimed in claim 3, wherein the system comprises a sliding mechanism coupled with at least one sidewall among the plurality of sidewalls and operatively configured with the one or more lids, such that upon sliding of the one or more lids towards the open position, the sliding mechanism activates the holding mechanism towards the deployed position.

5. The system as claimed in claim 4, wherein the sliding mechanism comprises one or more rails and one or more sliding elements arranged with a rope and a pulley assembly, wherein the sliding mechanism is operatively coupled with the one or more lids via the rope and the pulley assembly and the one or more holding elements, and wherein the sliding mechanism is configured to support the holding mechanism inside the housing in a retracted position and outside the housing in the deployed position.

6. The system as claimed in claim 5, wherein each sliding element among the one or more sliding elements comprises a slot at an end away from the pulley, wherein an end of the rope slides in the slot causing the delay in sliding the one or more sliding elements towards the deployed position of the holding mechanism.

7. The system as claimed in claim 5, wherein the system comprises a rotation mechanism comprising:
a rack and a pinion arrangement, wherein the pinion comprises a roller coaxial with the pinion such that the axis of rotation of the roller coincides with the axis of rotation of the pinion, and wherein the axis of rotation of the roller and the pinion is parallel with the axis of rotation of the pulley;
the rope is adapted to be fixed onto the roller such that a rotation of the roller with the pinion causes winding and unwinding of the rope onto the roller resulting in the movement of the holding mechanism in between the retracted position and the deployed position.

8. The system as claimed in claim 7, wherein the winding and unwinding of the rope onto the roller is the result of an engagement of a first locking pin of the pinion with a second locking pin of the roller.

9. The system as claimed in claim 8, wherein the one or more holding elements and a bottom plate of the holding mechanism at least partially moves out after the engagement of the first locking pin of the pinion with the second locking pin of the roller, wherein the one or more lids are configured to at least partially open before the one or more holding elements and a bottom plate at least partially moves out.

10. The system as claimed in claim 2, wherein the activation of the holding mechanism to the deployed position facilitates an expansion or contraction of the one or more holding elements and the bottom plate, corresponding to a shape or a size of the article, wherein the size of the article corresponds to a width of a base of the article.

11. The system as claimed in claim 9, wherein the sliding of the one or more lids in a linear direction with respect to the at least one sidewall causes an arcuated movement of the one or more sliding elements, such that the arcuated movement of the one or more sliding element causes arcuated movement of the one or more holding elements and the bottom plate at least partially outside the storage space of the housing to move the holding mechanism into the deployed position.

12. The system as claimed in claim 2, wherein each of the one or more holding elements comprises a plurality of intersecting diagonal bars hingedly connected to form scissor-like structure, wherein a bottom end of at least one of the diagonal bars is attached to the bottom plate.

13. The system as claimed in claim 1, wherein the housing is adaptively arranged in a side trim part of a trunk or central console of a vehicle, wherein the holding mechanism is configured to be hidden under the housing.

14. The system as claimed in claim 6, wherein:
the one or more lids is a pair of lids sliding opposite to each other such that upon sliding of the pair of lids from the closed position towards the open position:
firstly, only a first end of the rope slides within the slot until the lids move to an intermediate open position or till the first end of the rope travels and abut a distal end of the slot, and
then, the one or more sliding elements along with the rope slides towards the deployed position of the holding mechanism, enabling the expansion of the one or more holding elements and the bottom plate adapted to receive the article therein/thereon.

15. The system as claimed in claim 8, wherein:
the one or more lids is a pair of lids sliding opposite to each other such that when the pinion is driven in first direction by an electric motor:
only the rack along with the lids move towards the open position until, the first locking pin abut or engage with the second locking pin to wind/roll the rope on the roller and simultaneously slides the sliding element on the rail enabling the expansion of the holding element and the bottom plate towards the deployed position adapted for receiving the articles thereon/therein.
